(19) United States
(12) Patent Application Publication
(10) Pub. No.: US 2024/0242612 A1
(43) Pub. Date: Jul. 18, 2024

(54) METHOD AND WARNING DEVICE FOR WARNING A FOLLOWING VEHICLE ON A DEFINED ROADWAY SECTION ABOUT AN OBSTACLE

(71) Applicant: Continental Automotive Technologies GmbH, Hannover (DE)

(72) Inventors: Dominik Senninger, Burglengenfeld (DE); Helmut Hamperl, Cham (DE); Matthias Wagner, Beutelsbach (DE)

(73) Assignee: Continental Automotive Technologies GmbH, Hannover (DE)

(21) Appl. No.: 18/553,399

(22) PCT Filed: Mar. 18, 2022
(86) PCT No.: PCT/DE2022/200048

§ 371 Date: Mar. 28, 2024

(30) Foreign Application Priority Data
Mar. 30, 2021 (DE) 10 2021 203 186.2

(51) Int. Cl. G08G 1/16; G08G 1/01

(52) U.S. Cl. CPC G08G 1/164; G08G 1/0125

(57) ABSTRACT

A method and device for warning a following vehicle on a defined roadway section about an obstacle. Ego trajectories of ego vehicles moving on the roadway section are captured in a first time interval and a first swarm trajectory is formed therefrom and stored with a first time stamp. A second swarm trajectory is formed from ego trajectories of ego vehicles moving on the roadway section in a second time interval, the second time interval being offset in time from the first time interval. The second swarm trajectory is stored with a second time stamp. A difference between the first and second trajectories and an associated difference magnitude are formed. If this difference magnitude is greater than a predetermined threshold, an obstacle is recognized as being present on the roadway section and a warning signal is output to a following vehicle.

### CROSS-REFERENCE TO RELATED APPLICATIONS

The present application is a National Stage Application under 35 U.S.C. § 371 of International Patent Application No. PCT/DE2022/200048 filed on Mar. 18, 2022, and claims priority from German Patent Application No. 10 2021 203 186.2 filed on Mar. 30, 2021, in the German Patent and Trademark Office, the disclosures of which are herein incorporated by reference in their entireties.

### TECHNICAL FIELD

The invention relates to a method and a warning device for warning a following vehicle on a defined roadway section about an obstacle.

### BACKGROUND

It is known that vehicles are able to automatically detect obstacles on roadway sections with the aid of their vehicle sensors specifically provided for this purpose. Data relating to detected obstacles can then be sent to following vehicles, for example via a backend or directly via V2X communication, in order to warn them. Such following vehicles, to which data relating to potential obstacles are communicated from the backend or directly via V2X communication, can react early and, for example, warn the driver and thus help to avoid accidents.

Since the detection described above is carried out by dedicated vehicle sensors, however, only those vehicles which are equipped with these usually expensive vehicle sensors can participate in the detection of the obstacles. In addition, such vehicle sensors may not be able to detect all obstacles that would be detected by a human being, for example.

Due to the resulting reduced coverage of obstacle detection and the reduced reliability compared to human obstacle detection, warning signals that are output to following vehicles on the basis of automated detections of obstacles on roadway sections should rather be classified as unreliable.

### SUMMARY

An object of the present disclosure is therefore to specify a method and a warning device for warning a following vehicle on a defined roadway section about an obstacle, which are more reliable than the previously known methods and devices.

This object is addressed with a method for warning a following vehicle on a defined roadway section about an obstacle with the combination of features of claim 1.

The coordinate claim relates to a warning device for warning a following vehicle on a defined roadway section about an obstacle.

The dependent claims relate to advantageous configurations of the present disclosure.

A method for warning a following vehicle on a defined roadway section about an obstacle has the following steps:
capturing a multiplicity of ego trajectories of ego vehicles moving on the defined roadway section in a first time interval;
forming a first swarm trajectory from the multiplicity of ego trajectories captured in the first time interval;
storing the first swarm trajectory together with a first time stamp;
capturing a multiplicity of ego trajectories of ego vehicles moving on the defined roadway section in a second time interval, the second time interval being offset in terms of time with respect to the first time interval;
forming a second swarm trajectory from the multiplicity of ego trajectories captured in the second time interval;
storing the second swarm trajectory together with a second time stamp;
forming a difference between the first swarm trajectory and the second swarm trajectory;
detecting an obstacle present on the roadway section if a magnitude of the formed difference is greater than a predetermined threshold value;
outputting a warning signal to a following vehicle which is moving behind the ego vehicles in terms of time on the defined roadway section.

In contrast to known methods, in the method described above, obstacles on driving sections of roads, for example, are detected by detecting changes in swarm trajectories over time.

Swarm trajectories are created from the movement data of ego vehicles. If there is a sudden, statistically significant local change in the swarm trajectory over time, e.g. as a result of performed evasive maneuvers, this indicates an obstacle on the roadway section. Such evasive maneuvers are usually initiated by people who control the ego vehicles, so that the people or the drivers themselves serve as sensors and obstacles that can normally be detected only with difficulty by dedicated vehicle sensors can also be reliably detected. Basically, the advantage of the method is that no special vehicle sensors are required in the vehicle in comparison to direct obstacle detection by vehicle sensors.

On the defined roadway section, the swarm trajectory is determined by a multiplicity of successively arranged trajectory positions or trajectory points with a value in the direction of travel and a value arranged perpendicular thereto on the roadway section. If both types of values are represented in a coordinate system, the y-value represents the direction of travel, while the x-value is arranged perpendicular thereto. To form the difference, the difference between the x-values of the first and second swarm trajectories to be compared is preferably formed at a predetermined y-value, and so the deviation in the x-direction is decisive.

The multiplicity of ego trajectories are captured by using GNSS data (GNSS=Global Navigation Satellite System) of the ego vehicles and/or by using triangulated mobile radio data from mobile radio modules arranged in the ego vehicles.

Due to the use of GNSS data or mobile radio data, there are a very large number of ego vehicles that participate in obstacle detection. This increases the coverage of the road network and the reliability of the data determined.

The first and the second time interval, in which the ego trajectories are captured, may be constant in terms of time and, for example, cover a period of 10 min. However, it is also possible for the first and the second time interval to be flexible in terms of time and to be determined by a predetermined number of ego vehicles that pass through the defined roadway section. For example, a swarm trajectory may be formed from a multiplicity of ego trajectories only when at least 10 ego vehicles have passed through the defined roadway section.

For example, the first time interval and the second time interval may also overlap in terms of time.

To form the difference, a second swarm trajectory is advantageously selected, the second time stamp of which is offset in terms of time by at least 20 min, in particular at least 10 min, and more particularly at least 5 min, with respect to the first time stamp of the first swarm trajectory.

The predetermined threshold value may be 10 m, in particular 5 m, and more particularly 2 m.

If the result is therefore a difference magnitude of the x-value of second swarm trajectories, which have been determined with an offset in terms of time of 10 min with respect to one another for example, of at least 2 m, it may be concluded that an object has reached the roadway section, for example, and is evaded by the ego vehicles, the ego trajectories of which have been used to form the second swarm trajectory. If the difference magnitude is even 5 m or more, it may even be assumed that a vehicle has broken down or that there has been another accident.

In the method, instead of the absolute difference in the x-value of the two swarm trajectories to be compared, the difference magnitude is used in order to thus take into account obstacles that may reach the roadway section from both sides perpendicular to the direction of travel y.

If an obstacle has now been reliably detected using the method described, a correspondingly reliable warning signal may be output to a following vehicle which is moving behind the ego vehicles in terms of time on the defined roadway section with the obstacle.

The obstacle present on the roadway section may be detected by a backend, with the warning signal being output by the backend to the following vehicle.

The backend advantageously processes ego trajectories, which have been transmitted from the ego vehicles to the backend, to form the swarm trajectories, compares them and, by forming the difference in the x-value, detects whether an obstacle has meanwhile reached the roadway section. The backend then outputs the warning signal directly to the following vehicle to warn it about the obstacle and prepare the driver to initiate an evasive maneuver.

Advantageously, a multiplicity of ego driving speeds, at which the ego vehicles pass through the defined roadway section, are captured in the first time interval and in the second time interval, wherein average speeds for the first and for the second time interval are determined from the ego driving speeds, wherein a difference between a first average speed for the first time interval and a second average speed for the second time interval is formed, wherein an obstacle present on the roadway section is detected if the difference is greater than 50%, in particular greater than 70%, of the first average speed.

A change in the average speed of ego vehicles that pass through the defined roadway section is another indicator of an obstacle. This is because vehicles usually slow down in the area of obstacles. If this reduction in average speed is significant, i.e., greater than approximately 50% or even 70%, this clearly indicates an obstacle on the defined roadway section. With appropriate processing of this information, for example in the backend, an obstacle detected in this way may then be sent as a warning to following vehicles following the ego vehicles.

As with the first and second swarm trajectories, average speeds which are calculated from the ego driving speeds are compared. A difference is calculated from these average speeds, with the magnitude not being relevant here, but rather the information as to whether the second average speed is significantly lower than the first average speed. For this reason, the evaluation does not work with the difference magnitude, as is the case when comparing the swarm trajectories, but with the absolute value of the difference. If the second average speed is significantly lower than the first average speed, there is a relatively large difference. This is not the case if the two average speeds are similar, in which case a relatively small difference would arise when forming the difference. Therefore, if the difference is greater than 50% or even 70% of the first average speed, this means that the second average speed is low and the ego vehicles slow down significantly on the defined roadway section, which clearly indicates an obstacle.

For example, if the first average speed is thus 50 km/h and the second average speed is only 10 km/h, then the difference, namely 40 km/h, is 80% of the first average speed.

An advantageous warning device for warning a following vehicle on a defined roadway section about an obstacle is designed to carry out the method as described above. The warning device has a processing device for forming the first and second swarm trajectories from the multiplicity of ego trajectories in each case, and a memory device for storing the formed first and second swarm trajectories together with their associated first and second time stamps. The warning device also has a comparison device for forming the difference magnitude of the first and second swarm trajectories, an evaluation device for comparing the difference magnitude with the predetermined threshold value and for detecting the obstacle when the threshold value is exceeded by the formed difference magnitude, and a warning apparatus for outputting the warning signal to the following vehicle.

As a result, the warning device is formed in such a way that it may detect an obstacle on the defined roadway section from an abrupt change in the course of the swarm trajectories and may output this information as a warning signal to following vehicles.

The processing device is advantageously designed to determine average speeds and the comparison device is designed to form the difference between the average speeds. The evaluation device is also advantageously designed to compare the formed difference between the average speeds with the first average speed and to detect the obstacle if there is a difference of more than 50%, in particular 70%, of the first average speed.

As a result, the warning device is not only designed to detect the obstacle on the basis of an abrupt change in the course of the swarm trajectories, but also to additionally evaluate the ego driving speeds in such a way as to recognize that ego vehicles are suddenly passing through the defined roadway section at a lower driving speed and also to find out that there is an obstacle on the defined roadway section.

### DESCRIPTION OF THE DRAWINGS

An advantageous configuration of the invention will be explained in more detail below on the basis of the appended drawings, in which:

FIG. 1 shows a schematic plan view of a defined roadway section with ego vehicles moving thereon and a first swarm trajectory resulting from ego trajectories of these ego vehicles in a first time interval [t₁; t₂];

FIG. 2 shows a schematic plan view of the defined roadway section from FIG. 1 in a second time interval [t₃; t₄] with ego vehicles moving thereon and a second swarm trajectory resulting from the ego trajectories of the ego vehicles;

FIG. 3 shows a schematic representation of forming a difference between the first swarm trajectory from FIG. 1 and the second swarm trajectory from FIG. 2; and

FIG. 4 shows a schematic flowchart illustrating steps of a method for warning a following vehicle on the defined roadway section from FIG. 2 about an obstacle.

### DETAILED DESCRIPTION

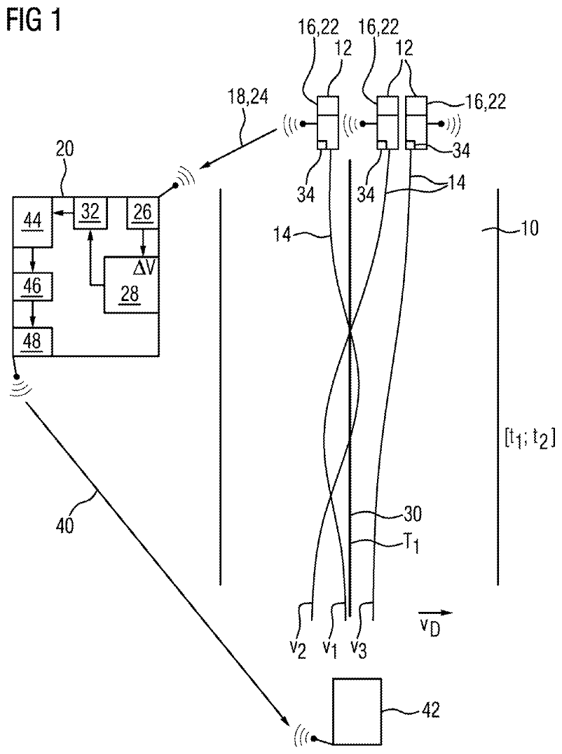

FIG. 1 shows a schematic plan view of a defined roadway section 10 in a first time interval [t₁; t₂]. Three ego vehicles 12 move along their associated ego trajectories 14 on the roadway section 10, each at their own driving speed v₁, v₂, v₃. All three ego vehicles 12 send their GNSS data 18 captured via GNSS receivers 16 to a backend 20. Alternatively or additionally, it is also possible for the ego vehicles 12 to have mobile radio modules 22 and then to be able to send triangulated mobile radio data 24 to the backend 20. It is possible to infer the ego trajectories 14 of the ego vehicles 12 from the GNSS data 18 or the mobile radio data 24. In order to receive the data from the ego vehicles 12, the backend 20 has a backend receiver 26. In a processing device 28, the backend 20 then processes the data received from the ego vehicles 12—GNSS data 18 and/or mobile radio data 24—to form a swarm trajectory 30. The backend 20 then stores this swarm trajectory 30 in a memory device 32 together with a time stamp T1.

The ego vehicles 12 use speed capture modules 34 to capture their ego driving speeds v₁, v₂, v₃, at which they pass through the roadway section 10 in the first time interval [t₁; t₂]. The captured ego driving speeds v₁, v₂, v₃ are then also sent to the backend 20, received there by the backend receiver 26 and then processed in the processing device 28 to form an average speed v_{D}.

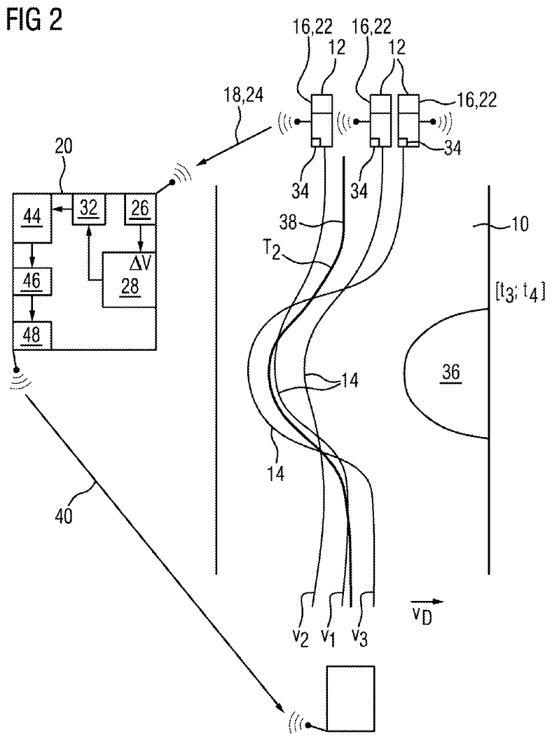

FIG. 2 shows a further plan view of the roadway section 10 from FIG. 1, but in a different, second time interval [t₃; t₄] later than the first time interval [t₁; t₂]. It may be seen that in the meantime an obstacle 36 has reached the right-hand side of the roadway section 10. The ego vehicles 12 which pass through the roadway section 10 during the second time interval [t₃; t₄] evade this obstacle 36, as a result of which their ego trajectories 14 no longer run in a straight line on the roadway section 10, as is approximately the case in FIG. 1, but have a bend.

If these ego vehicles 12 in FIG. 2 now send their GNSS data 18 or mobile radio data 24 to the backend 20, the processing device 28 uses the data to form a second swarm trajectory 38 which has a significantly different course than the first swarm trajectory 30. The backend 20 stores this second swarm trajectory 38 with a second time stamp T2 in the memory device 32.

As a result of the obstacle, the ego vehicles 12 also drive at reduced driving speeds v₁, v₂, v₃ over the roadway section 10, that is to brake before the obstacle 36 and bypass it more slowly than if they could pass through the roadway section 10 without impairment. As a result, lower ego driving speeds v₁, v₂, v₃ are also captured by the speed capture modules 34 of the ego vehicles 12 and sent to the backend 20, with the result that the processing device 28 calculates a lower average speed v_{D} therefrom.

The backend 20 in FIG. 1 and FIG. 2 is now designed to process this information from the ego vehicles 12 that bypass the obstacle 36 in such a way that the backend 20 may send a warning signal 40 to a following vehicle 42 that follows the ego vehicles 12 in terms of time on the roadway section 10.

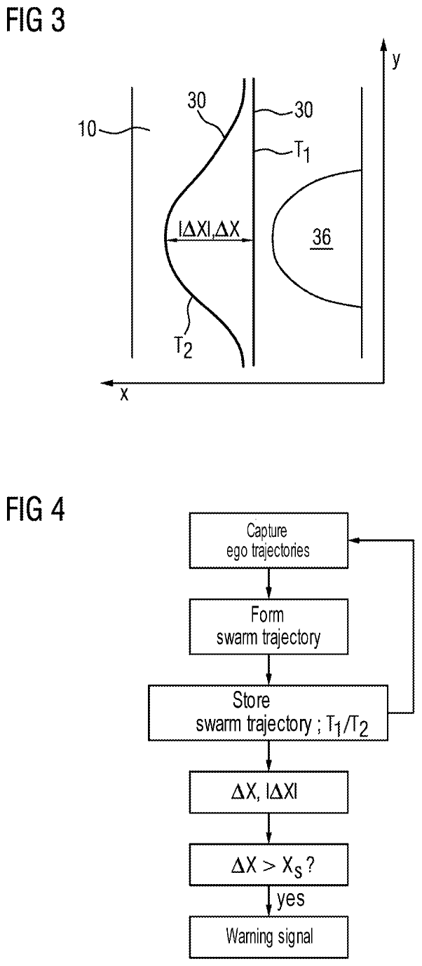

For this purpose, the backend 20 has a comparison device 44 which forms a difference magnitude |Δx| between the first swarm trajectory 30 and the second swarm trajectory 38. This is shown schematically in FIG. 3. A Cartesian coordinate system with the y-axis in the direction of travel of the ego vehicles 12 and the x-axis perpendicular thereto is shown. To form the difference magnitude |Δx|, the x-values of the two swarm trajectories 30, 38 are subtracted from one another at a multiplicity of predefined y-values and the magnitude is formed from the result.

In an evaluation device 46 of the backend 20, this difference magnitude |Δx| is then compared with a predetermined threshold value xₛ and it is detected that the obstacle 36 is present on the roadway section 10 if the difference magnitude |Δx| exceeds this threshold value xₛ. The threshold value xₛ may, for example, be generously selected at 10 m, but it is also possible to provide lower threshold values xₛ, such as 5 m or 2 m. Depending on the size of the obstacle 36, this threshold value xₛ thus defines whether the disruption caused by the obstacle 36 is worth warning a following vehicle 42 about.

If the evaluation device 46 determines that the threshold value xₛ is exceeded and thus detects the obstacle 36, a warning apparatus 48 in the backend 20 outputs the warning signal 40 to the following vehicle 42. A driver of the following vehicle 42 is thus prepared for the fact that he will soon encounter an obstacle 36 on roadway section 10 to be driven on, and may adjust himself and his journey accordingly.

It is of course also possible to accordingly warn following vehicles 42 that are driving autonomously about the obstacle 36, so that the autonomous systems may also prepare for avoiding hitting the obstacle 36 by adapting the control of the following vehicle 42 accordingly.

As already mentioned in relation to FIG. 1 and FIG. 2, the ego vehicles 12 also transmit their ego driving speeds, v₁, v₂, v₃, with the result that the processing device 28 may form average speeds v_{D} therefrom. These average speeds v_{D} are also stored in the memory device 32 with the corresponding time stamp T1, T2. The comparison device 44 compares the average speed v_{D}, which is assigned to the first time stamp T1 and thus to the first time interval [t₁; t₂], with the average speed v_{D}, which is assigned to the second time stamp T2 and thus to the second time interval [t₃; t₄], by forming a difference Δv between the average speeds v_{D}. This difference Δv is then assessed by the evaluation device 46 by comparing the difference Δv with the first average speed v_{D}. If the difference Δv is in a range of greater than 50% or even greater than 70% of the first average speed v_{D}, the evaluation device 46 decides that the obstacle 36 is present on the roadway section 10, and the backend 20 outputs the warning signal 40 to the following vehicle 42 via the warning apparatus 48.

FIG. 4 shows a schematic flowchart illustrating the steps of the method for warning the following vehicle 42 about the obstacle 36.

First of all, a multiplicity of ego trajectories 14 are captured and are to be assigned to ego vehicles 12 which are moving on the roadway section 10 in the first time interval [t₁; t₂]. The first swarm trajectory 30 is then formed therefrom in the next step and this is then stored together with the first time stamp T1 in a further step. As the method continues, a further multiplicity of ego trajectories 14, now in the second time interval [t₃; t₄], are captured, a second swarm trajectory 38 is formed therefrom and this is also stored together with its second time stamp T2. In a further step of the method, a difference Δx between the two swarm trajectories 30, 38 and at the same time an associated difference magnitude |Δx| are formed.

In the next step, it is detected whether an obstacle 36 is present on the roadway section 10 if the difference magnitude determined |Δx| is greater than a predetermined threshold value xₛ. If this is the case, then in the last step a warning signal 40 is output to the following vehicle 42.

### LIST OF REFERENCE SIGNS

10 Roadway section
12 Ego vehicle
14 Ego trajectory
16 GNSS receiver
18 GNSS data
20 Backend
22 Mobile radio module
24 Mobile radio data
26 Backend receiver
28 Processing device
30 First swarm trajectory
32 Memory device
34 Speed capture module
36 Obstacle
38 Second swarm trajectory
40 Warning signal
42 Following vehicle
44 Comparison device
46 Evaluation device
48 Warning apparatus
T1 First time stamp
T2 Second time stamp
[t₁; t₂] First time interval
[t₃; t₄] Second time interval
v_{D} Average speed
v₁, v₂, v₃ (Ego) driving speed
Δv Difference
xₛ Threshold value
Δx Difference
   |Δx| Difference magnitude

1. A method for warning a following vehicle on a defined roadway section about an obstacle, the method comprising:
receiving, by a backend having a processor, a multiplicity of ego trajectories of ego vehicles moving on a defined roadway section captured in a first time interval;
forming, by the processor, a first swarm trajectory from the multiplicity of ego trajectories captured in the first time interval;
storing, by the processor, the first swarm trajectory together with a first time stamp;
receiving, by the processor, a multiplicity of ego trajectories of ego vehicles moving on the defined roadway section captured in a second time interval, the second time interval being offset in terms of time with respect to the first time interval;
forming, by the processor, a second swarm trajectory from the multiplicity of ego trajectories captured in the second time interval;
storing, by the processor, the second swarm trajectory together with a second time stamp in memory;
forming, by the backend, a difference between the first swarm trajectory and the second swarm trajectory;
detecting, by the backend, an obstacle present on the roadway section if a magnitude of the formed difference is greater than a predetermined threshold value xₛ;
outputting, by the backend from an output thereof, a warning signal to a following vehicle which is moving behind the ego vehicles in terms of time on the defined roadway section.

2. The method as claimed in claim 1, wherein the multiplicity of ego trajectories are captured by at least one of using GNSS data of the ego vehicles or using triangulated mobile radio data from mobile radio modules arranged in the ego vehicles.

3. The method as claimed in claim 1, wherein the second time stamp of the second swarm trajectory is offset in terms of time by at least 20 min with respect to the first time stamp of the first swarm trajectory.

4. The method as claimed in claim 1, wherein the predetermined threshold value is 10 m.

5. The method as claimed in claim 1, wherein the obstacle present on the roadway section is detected by the backend, with the warning signal being output by the backend to the following vehicle.

6. The method as claimed in claim 1, further comprising:
receiving a multiplicity of ego driving speeds, at which the ego vehicles pass through the defined roadway section, in the first time interval and in the second time interval, wherein
determining average speeds for the first time interval and for the second time interval from the ego driving speeds,
forming a difference between a first average speed for the first time interval and a second average speed for the second time interval,
wherein the obstacle present on the roadway section is detected if the difference is greater than 50% of the first average speed.

7. A warning device for warning the following vehicle on the defined roadway section about the obstacle, wherein the warning device is configured to carry out the method as claimed in claim 6, wherein the warning device comprises the backend and has:
the processing device for forming the first and second swarm trajectories from the multiplicity of ego trajectories in each case;
the memory for storing the formed first and second swarm trajectories together with the associated first and second time stamps;
a comparison device having an input connected to an output of the memory for forming the difference magnitude of the first and second swarm trajectories;
an evaluation device having an input connected to an output of the comparison device, for comparing the difference magnitude with the predetermined threshold value and for detecting the obstacle when the threshold value is exceeded by the formed difference magnitude;
a warning apparatus having an input connected to an output of the evaluation device, for outputting the warning signal to the following vehicle.

8. The warning device as claimed in claim 7, wherein the processing device is designed configured to determine average speeds, wherein the comparison device is configured to form the difference between the average speeds, wherein the evaluation device is configured to compare the formed difference between the average speeds with the first average speed and to detect the obstacle if there is a difference of more than 50% of the first average speed.

9. The method as claimed in claim 1, wherein the predetermined threshold value is no more than 5 m.

10. The method as claimed in claim 1, wherein the second time stamp of the second swarm trajectory is offset in terms of time by at least 10 min or by at least 5 min with respect to the first time stamp of the first swarm trajectory.

11. The method as claimed in claim 6, wherein the obstacle present on the roadway section is detected if the difference is greater than 70% of the first average speed.
